(19) United States
(12) Patent Application Publication
(10) Pub. No.: US 2012/0077279 A1
(43) Pub. Date: Mar. 29, 2012

(54) Silica Nanoparticles Incorporating Chemiluminescent And Absorbing Active Molecules

(75) Inventors: Ulrich B. Wiesner, Ithaca, NY (US); Erik Herz, Brookhaven, PA (US)

(73) Assignee: CORNELL UNIVERSITY, Ithaca, NY (US)

(21) Appl. No.: 13/263,375

(22) PCT Filed: Apr. 15, 2010
(86) PCT No.: PCT/US10/31297

§ 371 Date: Dec. 19, 2011

Related U.S. Application Data
(60) Provisional application No. 61/169,605, filed on Apr. 15, 2009.

(51) Int. Cl. G01N 21/76; B32B 5/16; B82Y 15/00

(52) U.S. Cl. 436/135; 436/172; 428/402; 977/773; 977/902

(57) ABSTRACT

Nanoparticles incorporating absorbing materials, e.g., an absorber dye, which under appropriate conditions exhibit chemiluminescence. The nanoparticles can be mesoporous silica nanoparticles or core-shell silica nanoparticles. The nanoparticles can be used as sensors to detect an analyte.

### CROSS-REFERENCE TO RELATED APPLICATIONS

This application claims priority to U.S. provisional patent application No. 61/169,605, filed Apr. 15, 2009, the disclosure of which is incorporated herein by reference.

### FIELD OF THE INVENTION

The present invention relates generally to silica nanoparticles containing absorber dyes. More particularly, the present invention relates to mesoporous silica nanoparticles and core-shell nanoparticles containing absorbing and/or chemiluminescent materials and uses thereof.

### BACKGROUND OF THE INVENTION

Chemiluminescence from concerted peroxide decomposition reactions was invented by M. M. Rauhut in 1969. This kind of light emission is the result of a chemical reaction in which a fluorophore is excited by a high energy product (in this case: 1,2-dioxethanedione). This highly unstable intermediate is produced in a SN₂-reaction between hydrogen peroxide and a phenyloxalate. When the energy of the 1,2-dioxethanedione is transferred to the dye molecule, the intermediate dissociates into carbon dioxide. The fluorophore releases the absorbed energy as light, which can then be detected with suitable instruments. The mechanism of the reaction is shown in FIG. 1.

In theory, one photon of light should be given off for each molecule of reactant. But Rauhut designed a phenyl oxalate ester that, when mixed with hydrogen peroxide and a dye, gave a quantum yield of around 5-50%. Please note that this quantum efficiency is high for chemiluminescence reactions, but compared to living organisms, like fireflies, which produce bioluminescence (in fact, when a reaction of this nature occurs in living organisms, it is called bioluminescence), the efficiency of the designed reaction is very low. With a quantum yield of 88%, the firefly reaction has the highest known efficiency of chemiluminescence. In the firefly bioluminescent reaction, adenosine triphosphate (ATP), luciferin and the enzyme luciferase are involved. The resulting intermediate combines with oxygen to produce a highly chemiluminescent product.

Although the system that fireflies use is very quantum efficient, it is not desirable for use in some applications.

### BRIEF SUMMARY OF THE INVENTION

The present invention provides nanoparticles incorporating absorbing materials, e.g., a absorber dye, which under appropriate conditions exhibit chemiluminescence. The nanoparticles can be mesoporous silica nanoparticles or core-shell silica nanoparticles. The nanoparticles can be used as sensors to detect an analyte.

In one embodiment, the present invention provides a mesoporous silica nanoparticle comprising an absorbing material covalently linked to the silica network. The absorbing material can absorb electromagnetic energy of from 300 nm to 1200 nm, and on exposure to the appropriate chemical species the absorbing material exhibits chemiluminescent emission. The longest dimension of the nanoparticle can be from 1 to 500 nm.

In one embodiment, the silica nanoparticle also comprises a chemical species, e.g., an oxalate species, that under the appropriate conditions can react to form a high-energy chemical species which on exposure to the absorbing material results in chemiluminescent emission.

In one embodiment, the silica nanoparticle has a pores of from 1 to 20 nm. In one embodiment, the longest dimension of the nanoparticles is from 1 to 100 nm. In one embodiment, the absorbing material is an absorbing dye, e.g., ADS832WS and succinimidyl ester (DNP-X SE).

In another embodiment, the present invention provides a silica nanoparticle with a core-shell structure. The silica core comprises an absorbing material, wherein the absorbing material is covalently linked to the silica network of the core, wherein the absorbing material absorbs electromagnetic energy of from 300 nm to 1200 nm, and wherein on exposure to a chemical species the absorbing material exhibits chemiluminescent emission. The longest dimension of the nanoparticle is 1 to 500 nm.

In one embodiment, the silica nanoparticle further comprises a chemical species, e.g. an oxalate, which can react to form a high-energy chemical species which on exposure to the absorbing material results in chemiluminescent emission.

In one embodiment, the longest dimension of the nanoparticles is from 1 to 100 nm. In one embodiment, the absorbing material is ADS832WS or succinimidyl ester (DNP-X SE).

In another aspect, the present invention provides a method for detecting a chemical species. In one embodiment, the method comprises the steps of: (a) providing a nanoparticle such as, for example, a mesoporous nanoparticle or mesoporous nanoparticles or core-shell or core-shell nanoparticles as described herein; (b) exposing the nanoparticle(s) to an environment comprising an analyte chemical species under conditions resulting in chemiluminescent emission from the nanoparticle(s); and (c) detecting the chemiluminescent emission which demonstrates the presence of the analyte chemical species.

In one embodiment, the nanoparticles are used to detect an analyte such as, for example, hydrogen peroxide.

In one embodiment, the environment further comprises a chemical species (e.g., oxalate) which can react with the analyte to form a high-energy chemical species (e.g., 1,2-ethanedione).

Detection of an analyte as a function of time can be carried out by using nanoparticles which respond differently as a function of time to the analyte. In one embodiment, mesoporous nanoparticle(s) have pores which are functionalized with a surfactant, which alters the diffusion of a chemical species through the nanoparticle relative to mesoporous nanoparticles which are not functionalized. In one embodiment, at least two different mesoporous nanoparticles have different absorber material and/or size and/or pore size and/or pore functionalization are used.

### BRIEF DESCRIPTION OF THE FIGURES

FIG. 1: Mechanism for the activation of a fluorophore.

FIG. 2. Chemical structure of ADS832WS.

FIG. 3. Schematic illustration of an example of mesoporous nanoparticle synthesis.

FIG. 4. Transmission electron images of examples of mesoporous nanoparticles. (a) 0.06 mol %; (b) 0.08 mol %; (c) 0.10 mol %; (d) 0.12 mol %; (e) 0.14 mol %; (f) 0.16 mol %; (g) 0.18 mol %; (h) 0.20 mol %; (i) 0.30 mol %; and (j) 0.40 mol %.

FIG. 5. Absorption matching for nanoparticles shown in FIG. 4 and free dye solution.

FIG. 6. Chemiluminescence decay over time for nanoparticles shown in FIG. 4 and free dye solution. The number of dyes are given in 10̂−8 moles per mg of particles.

FIG. 7. Maximum intensity peak for nanoparticles at 25 seconds.

FIG. 8. Chemiluminescence spectrum over time for 0.10 mol % nanoparticles.

FIG. 9. Absorption matching for nanoparticles shown in FIG. 4 and free dye solution.

FIG. 10. Maximum intensity peak for nanoparticles and free dye solution (last 2 spots to the right) at 25 seconds.

FIG. 11. Chemiluminescence spectrum over time for 0.10 mol % nanoparticles

FIG. 12. Absorption matching for 0.08 mol % nanoparticles and free dye solution.

FIG. 13. Chemiluminescence intensity peak at 25 seconds for 0.08 mol % nanoparticles that were activated with different amounts of hydrogen peroxide.

FIG. 14. Chemiluminescence spectrum over time for absorption matched free dye solution.

FIG. 15. Mechanism of the formation of N,N′-bis(3-(triethoxysilane)propyl)oxamide.

FIG. 16. Size analysis data for QXL490 core-shell nanoparticles (small particle syntheses) in ethanol from Brookhaven dynamic light scattering system.

FIG. 17. Size analysis data for DNP-X core-shell nanoparticles (small particle syntheses) in ethanol from Brookhaven dynamic light scattering system.

FIG. 18. Size analysis data for DNP-X core-shell nanoparticles (large particle synthesis) in ethanol from Brookhaven dynamic light scattering system.

FIG. 19. Size analysis data for QXL490 core-shell nanoparticles (large particle synthesis) in ethanol from Brookhaven dynamic light scattering system.

FIG. 20. DNP-X absorption data for ˜20 nm core-shell nanoparticles and free dye in ethanol. The dye structure is shown in the upper right.

FIG. 21. QXL490 absorption data for ˜20 nm core-shell nanoparticles and free dye in ethanol.

FIG. 22. DNP-X SEM images of ˜20 nm core-shell nanoparticles from SEM Keck Facility. (a) 1^{st} reaction; (c) 2^{nd} reaction.

FIG. 23. QXL490 SEM images of ˜20 nm core-shell nanoparticles from SEM Keck Facility. (a) 1^{st} reaction; (c) 2^{nd} reaction.

FIG. 24. DNP-X SEM image of 100 nm reaction of core-shell nanoparticles from SEM Keck Facility.

FIG. 25. QXL490 SEM images of 100 nm reaction of core-shell nanoparticles from SEM Keck Facility.

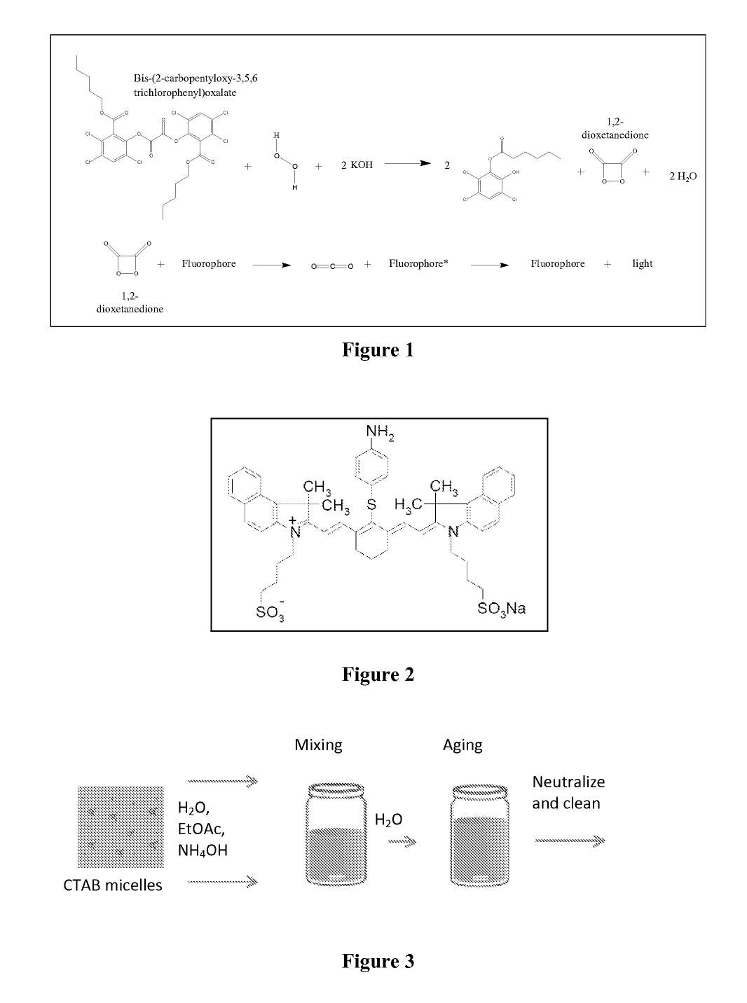

### DETAILED DESCRIPTION OF THE INVENTION

The present invention provides a composition comprising silica nanoparticles (e.g. mesoporous silica and core-shell nanoparticles) incorporating absorbing molecules (e.g., absorber dyes) and methods for producing the nanoparticles. These particles can be used in, for example, labeling, and sensor applications.

Some unique features of the invention include, but are not limited to: i.) the nanoparticles covered in this invention can incorporate organic optical absorbers; and ii.) in one embodiment mesoporous silica nanoparticles containing an absorber dye have been demonstrated to be chemiluminescent, and exhibit improved chemiluminescent behavior relative to the free dye.

The silica nanoparticles of the present invention can be, for example, mesoporous silica nanoparticles and core-shell nanoparticles. The nanoparticles having incorporated therein an absorbing molecule, e.g. an absorbing dye. Under the appropriate conditions, the nanoparticles emit electromagnetic radiation resulting from chemiluminescence.

Mesoporous silica nanoparticles can be from 5 nm to 500 nm in size, including all integers and ranges therebetween. The size is measured as the longest axis of the particle. In various embodiments, the particles are from 10 nm to 200 nm and from 10 nm to 100 nm in size. The mesoporous silica nanoparticles have a porous structure. The pores can be from 1 to 20 nm in diameter, including all integers and ranges therebetween. In one embodiment, the pores are from 1 to 10 nm in diameter. In one embodiment, 90% of the pores are from 1 to 20 nm in diameter. In another embodiment, 95% of the pores are 1 to 20 nm in diameter.

The mesoporous nanoparticles can be synthesized according to methods known in the art. In one embodiment, the nanoparticles are synthesized using sol-gel methodology where a silica precursor or silica precursors and a silica precursor or silica precursors conjugated (i.e., covalently bound) to absorber molecules are hydrolyzed in the presence of templates in the form of micelles. The templates are formed using a surfactant such as, for example, hexadecyltrimethylammonium bromide (CTAB). It is expected that any surfactant which can form micelles can be used.

The core-shell nanoparticles comprise a core and shell. The core comprises silica and an absorber molecule. The absorber molecule is incorporated in to the silica network via a covalent bond or bonds between the molecule and silica network. The shell comprises silica.

In one embodiment, the core is independently synthesized using known sol-gel chemistry, e.g., by hydrolysis of a silica precursor or precursors. The silica precursors are present as a mixture of a silica precursor and a silica precursor conjugated, e.g., linked by a covalent bond, to an absorber molecule (referred to herein as a “conjugated silica precursor”). Hydrolysis can be carried out under alkaline (basic) conditions to form a silica core and/or silica shell. For example, the hydrolysis can be carried out by addition of ammonium hydroxide to the mixture comprising silica precursor(s) and conjugated silica precursor(s).

Silica precursors are compounds which under hydrolysis conditions can form silica. Examples of silica precursors include, but are not limited to, organosilanes such as, for example, tetraethoxysilane (TEOS), tetramethoxysilane (TMOS) and the like.

The silica precursor used to form the conjugated silica precursor has a functional group or groups which can react with the absorbing molecule or molecules to form a covalent bond or bonds. Examples of such silica precursors includes, but is not limited to, isocyanatopropyltriethoxysilane (ICPTS), aminopropyltrimethoxysilane (APTS), mercaptopropyltrimethoxysilane (MPTS), and the like.

In one embodiment, an organosilane (conjugatable silica precursor) used for forming the core has the general formula R_{(4—n)}SiXₙ, where X is a hydrolyzable group such as ethoxy, methoxy, or 2-methoxy-ethoxy; R can be a monovalent organic group of from 1 to 12 carbon atoms which can optionally contain, but is not limited to, a functional organic group such as mercapto, epoxy, acrylyl, methacrylyl, or amino; and n is an integer of from 0 to 4. The conjugatable silica precursor is conjugated to an absorber molecule and subsequently cocondensed for forming the core with silica precursors such as, for example, TEOS and TMOS. A silane used for forming the silica shell has n equal to 4. The use of functional mono-, bis- and tris-alkoxysilanes for coupling and modification of co-reactive functional groups or hydroxy-functional surfaces, including glass surfaces, is also known, see Kirk-Othmer, Encyclopedia of Chemical Technology, Vol. 20, 3rd Ed., J. Wiley, N.Y. Although not intending to be bound by any particular theory, it is considered that the coupling arises as a result of hydrolysis of the alkoxysilane groups to silanol groups and as a result of condensation with hydroxyl groups of the surface, see E. Pluedemann, Silane Coupling Agents, Plenum Press, N.Y. 1982. The organo-silane can cause gels, so it may be desirable to employ an alcohol or other known stabilizers. Processes to synthesize core-shell nanoparticles using modified Stoeber processes can be found in U.S. patent applications Ser. Nos. 10/306,614 and 10/536, 569, the disclosure of such processes therein are incorporated herein by reference.

The absorbing materials do not spontaneously emit light. Under the appropriate conditions the absorbing materials undergo chemiluminescence. The absorbing materials can absorb electromagnetic radiation from 300 nm to 900 nm. Absorbing materials such as, for example, absorbing dyes or pigments can be used. In one embodiment, a NIR-absorber dye is incorporated in the nanoparticle.

Dyes with an absorption peak outside the spectral range of 400 nm to 700 nm are not visible under normal circumstances and, due to their absorbing nature, do not become visible under a UV lamp like many fluorescent dyes. Absorbing dyes exhibit very specific spectral peaks and are difficult to duplicate unless the specific dye is known, making them desirable in, for example, security devices. Therefore, the use of absorptive dyes in the ultraviolet, visible, and near infrared (NIR) regions of the spectrum in nanoparticles would add another dimension to labeling and expand the application of nanoparticles.

In one embodiment, the NIR dye ADS832WS is incorporated in the nanoparticle.

In embodiments, DNP-X and QXL490 absorbing dyes have been used to make core-shell nanoparticles approximately 20 nm in diameter. The absorption peaks for both DNP-X and QXL490 nanoparticles match those of their respective free dyes.

On exposure to an appropriate chemical stimulus, the absorbing dye emits electromagnetic radiation resulting from a chemiluminescent process. In this process a target analyte reacts with a second chemical species resulting in formation of a high-energy chemical species which can excite the absorbing material incorporated in the nanoparticle. The excited absorbing material then emits electromagnetic radiation.

In one embodiment, the chemical reactant (second chemical species), e.g. oxalate, may be retained in the nanoparticle structure. This could result in higher reactivity. For example, a di-(N-succinimidyl)oxalate could be reacted with a hydroxysilane with the aid of a coupling agent. An alternative to this procedure is to synthesize di-(N-maleinimidyl)oxalate. Mercaptosilanes are expected to react with the double bond of the maleimide and the resulting product can be integrated during the particle synthesis.

In one embodiment, the present invention provides a method for detecting the presence of a chemical species or moiety. For example, a mesoporous nanoparticle incorporating an absorbing material which exhibits chemiluminescence as a result of formation of a reactive species as a result of exposure to an analyte chemical species or moiety can be used as a sensor to detect the presence of the analyte (or target) chemical species or moiety. The detection of the emission of chemiluminescence resulting form the interaction of the chemical species or moiety with the nanoparticle demonstrates the presence of that chemical species or moiety.

In one embodiment, the presence of hydrogen peroxide and an oxalate moiety in proximity to the mesoporous and/or core-shell nanoparticle results in a chemical reaction forming a 1,2-dioxethanedione species which excites the absorbing material incorporated in the nanoparticle via energy transfer. The excited absorbing material then emits electromagnetic radiation. For example, if a system comprising the nanoparticle and oxalate are exposed to an environment containing hydrogen peroxide, the system can be used to detect the presence of hydrogen peroxide. As another example, if a system comprising the nanoparticle, oxalate and peroxide, where the oxalate and peroxide are not able to react (e.g., they are physically separated), is exposed to a force (e.g., a mechanical force) resulting in the oxalate and peroxide being able to react to form the 1,2-dioxethanedione species, the system can be used to detect the presence of the force.

Mesoporous nanoparticles incorporating absorbing materials are useful in that the porous nature (e.g., the pore size) of the nanoparticles controls the exposure of the absorbing material to the analyte chemical species or moiety (or alternatively, the second chemical species or moiety). The pores of the mesoporous nanoparticles can be modified (for example, with an organic molecules such as a surfactant) which retards access (diffusion) of the analyte chemical species or moiety to the absorbing moiety.

In one embodiment, a mixture of mesoporous nanoparticles with different porosity or pore modification (and thus, different rates of diffusion of the analyte chemical species through the porous silica) can be used. Thus, the chemiluminescence emission profile can be tailored as a function of time.

The following examples are presented to illustrate the present invention. They are not intended to limiting in any manner.

### EXAMPLE 1

### Preparation and Characterization of Mesoporous Silica Nanoparticles Containing Absorber Dye

### Materials and Methods:

Step 1—Dye Preparation:

The NIR-dye, ADS832WS, is dissolved into DMSO to make a 4.5 mmolar solution. (e.g., 30.23 mg dye into 7.169 mL DMSO).

Step 2—Conjugation

The DMSO-dye solution is conjugated in a 1:50 ratio with 3-Isocyanatopropyltriethoxysilane (ICPTS). (e.g. 40 μL+22.5 μL ICPTS).

As mentioned before, ADS832WS was used as the NIR-dye (λ_{Abs}=832 nm). The chemical structure of the dye is shown in FIG. 2.

Nanoparticles with a porous structure were desired. Nanoparticles which match this requirement are known as mesoporous silica nanoparticles. By reacting a template of micelles with tetraethylorthosilicate (TEOS), mesoporous silica nanoparticles are synthesized as spheres or rods that are filled with a regular arrangement of pores. By adding a dye during the synthesis, the dye is integrated into the silica walls. The large surface area of the pores should allow for the 1,2-dioxethanedione intermediate to diffuse to the dyes.

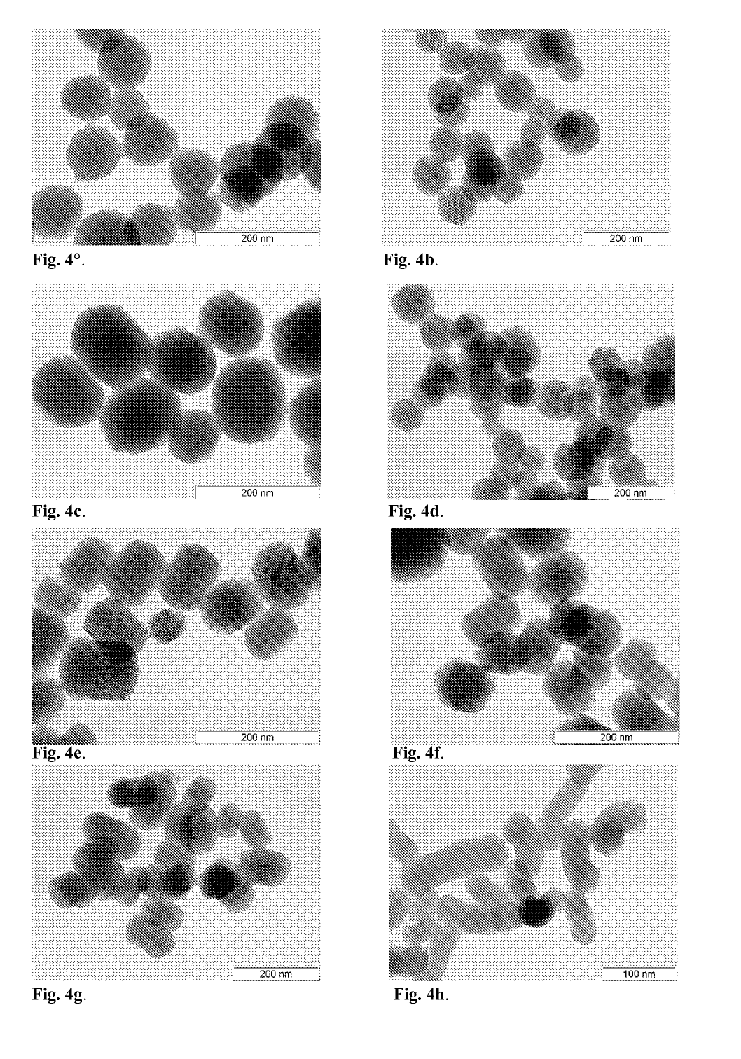

Synthesis of dye doped mesoporous silica nanoparticles. For a 10 mL reaction the following synthesis protocol was used: 10 mg hexadecyltrimethylammoniumbromide (CTAB) is dissolved in 0.5 mL DI-H₂O. 500 μL of the CTAB solution is added to 10 mL DI-H₂O. To form micelles, 88 μL of ethyl acetate is added and the solution is stirred for a few minutes. For the particle formation 270 μL ammonium hydroxide, x μL conjugated dye solution (where x is the desired amount of dye, 11, 33, 44, 55, 66, 77, 88, 99, 110, 165 and 200 μL) and 50 μL tetraethylorthosilicate were combined and stirred for 5 minutes. The reaction was diluted by adding 3690 μL of DI-water and stirred for a further 10 minutes. The reaction mixture was then neutralized with 2 molar hydrochloric acid. A schematic illustration of the synthesis is shown in FIG. 3.

To remove the CTAB, the formed particles were cleaned alternately with ethanol and DI-water. (Between each cleaning step the particles were spun down (10 min, 8000-9000 rpm) and resuspended in the appropriate solvent).

After 5 cleaning steps 500 μL of acetic acid was added to the particles in water. The solution was stirred for approximately one hour and another 5 cleaning steps follow.

By variation of the added amount of conjugated dye, eleven different types of particles were synthesized (0.02 mol %, 0.06 mol %, 0.08 mol %, 0.10 mol %, 0.12 mol %, 0.14 mol %, 0.16 mol %, 0.18 mol %, 0.20 mol %, 0.30 mol %, 0.40 mol %). All molar specifications are related to the moles of TEOS. The dye content was varied while the silica concentration remained the same.

For the particle tests 1 mL of each particle type was spun down for 10 min, 16000 rpm, and resuspended in 400 μL n-hexanol by sonication. A solution of phenyloxalate in ethyl acetate (e.g. 34 mg phenyloxalate in 15 mL ethyl acetate) was freshly prepared on the day of the chemiluminescence testing. 600 μL of this mixture was added to the particles in n-hexanol and mixed well.

For comparable results all particle mixtures were absorption matched, using a spectrophotometer, to the peak absorption of the 0.06 mol % particles before chemiluminescence testing. To maintain the conditions, the particle solutions were diluted with the same solvents and chemicals (n-hexanol, ethyl acetate, phenyloxalate) as used for the resuspension of the particles. After absorption matching, the particles were activated with hydrogen peroxide to produce the intermediate 1,2-dioxethanedione. Therefore 12 μL of a KOH/H₂O₂ solution (e.g. 4.0 mg KOH in 1 mL H₂O₂ (30%)) was added to the diluted nanoparticles and mixed well. Data were recorded after 25 s, 70 s and then every 40 s (e.g. 110 s, 150 s, etc.). The experiments generally lasted 3 minutes.

The nanoparticles demonstrate an improvement in chemiluminescence intensity compared to free dye-molecules at identical concentrations of dye and oxalate. All experiments were performed identically to the free dye chemiluminescence testing. (E.g., 2.3 mg ADS832WS and 43 mg phenyloxalate (Bis(2-carbopentyloxy-3,5,6-trichlorophenyl)oxalate) in 25 mL n-hexanol (1):ethyl acetate (1.5).) Each time 1 mL of the new solution was absorption matched to the absorption of 0.06 mol % particles.

To confirm the particle size and architecture, every particle type was characterized by TEM images. Therefore 10 μL of each particle solution were diluted with 10 μL ethanol and mixed well. Approximately 8 μL of this mixture was used to cover the copper carbon grid that is used for transmission electron microscopy. After drying in air, TEM imaging was performed.

### RESULTS AND DISCUSSION

For the synthesis of dye-doped mesoporous silica particles different amounts of dye were added. To confirm that more dye was incorporated, by adding higher amounts of dye, mass analysis and absorption measurements were made. These experimental data were necessary to calculate the moles of dye per mg of particles.

The extinction coefficient was calculated by using Lambert Beer's Law: A=c*d*ε. Where A is the optical density, c is the concentration, d is the pathlength and ε is the extinction coefficient. The extinction coefficient ε was obtained by absorption measurements of free dye solution, the concentration c of the free dye solution was known and the pathlength of the cuvette was known. The value of ε that was used for all calculations is 29195,678 L/(mol*cm). It was possible to calculate the concentration of the nanoparticle solutions cNS by dividing the experimental given optical density of each particle type ODNS by the calculated extinction coefficient ε.

To determine the moles of dye per milligram of particles, mass analysis was carried out. For statistical reasons 3 vials were filled with 300 μL of each type of particles and dried out in a vacuum oven over night. The obtained mass m_{NS} was used to calculate the amount of dye in the diluted nanoparticle solution m_{NSD}. With this value the moles of dye per milligram of particle were calculated by dividing the concentration c_{NS} by the milligram of dyes in the diluted solution m_{NSD}.

Table 1 shows the amount of dye (moles per mg of particles) in different particle types. Dye concentrations for these particles ranged from approximately one to 17×10⁻⁸ moles of dye per mg of particles.

TABLE 1
Moles per mg of particles for different particle types

| ADS832WS w.r.t [TEOS] | moles dye/mg particles |
|---|---|
| 0.06 mol % | 1.1 * 10⁻⁸ |
| 0.08 mol % | 2.7 * 10⁻⁸ |
| 0.10 mol % | 4.1 * 10⁻⁸ |
| 0.12 mol % | 5.8 * 10⁻⁸ |
| 0.14 mol % | 6.5 * 10⁻⁸ |
| 0.16 mol % | 7.0 * 10⁻⁸ |
| 0.18 mol % | 8.0 * 10⁻⁸ |
| 0.30 mol % | 1.7 * 10⁻⁷ |

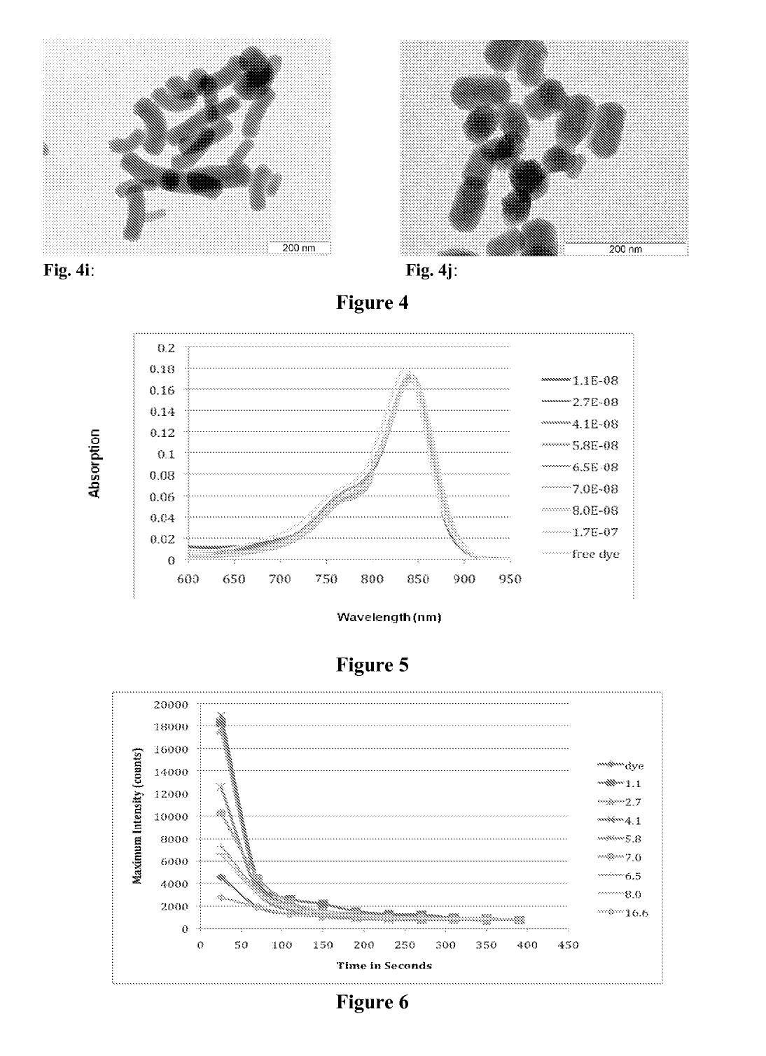

Transmission electron microscopy (TEM) were made to confirm the particle size and architecture. In FIGS. 4a-4j representative TEM images for dye doped mesoporous particles are shown. The images indicate that the nanoparticle structure changes when more dye was added during the synthesis. Particles with a low amount of dye formed sphere-like structures whereas those with higher amounts of dye formed rods. However, all of the particles show a greater or lesser extent of pores, but the porosity seems to decrease with higher dye incorporation.

The TEMs show that particles with a lower dye amount than 0.18 mol % are approximately 100 nm in size. Nanoparticles with higher dye amounts are slightly larger. The high amount of dye and the poorer developed pore structure of 0.14-0.18 mol % but most notably 0.20-0.40 mol % particles will turn out to cause difficulty in activating the chemiluminescence reaction (as indicated by the results presented later). This observation reinforces the assumption that the NIR-dyes quench themselves or that an activation of the dye is not possible when the dye is not accessible by the 1,2-dioxethanedione. But it should be noted that a low intensity chemiluminescence was detectable even for 0.40 mol % particles.

Chemiluminescence Activation with Hydrogen Peroxide and Potassium Hydroxide

The particle types shown in FIG. 4 and free dye solution were tested for chemiluminescence. In order to obtain comparable results, absorption matching was carried out on all particle types and is shown in FIG. 5. The optical density was matched to within 5% variation.

To match the absorption, the prepared nanoparticle- and dye solutions were each diluted with a mixture of n-hexanol, ethyl acetate and phenyloxalate (dilution mixture had the same composition as described earlier for the particles).

The diluted solutions were each activated with 12 μL KOH/H₂O₂ solution (see above). Because of moderate solubility of the aqueous solution and n-hexanol/ethyl acetate, the mixture was mixed well. After 25 s the first measurement was started. More data were recorded after 70 s and then every 40 s (e.g. 110 s, 150 s, etc.). In FIG. 6 the chemiluminescence decay is shown for each particle type as well as for free dye. After approximately 4 minutes all of the chemiluminescence was gone.

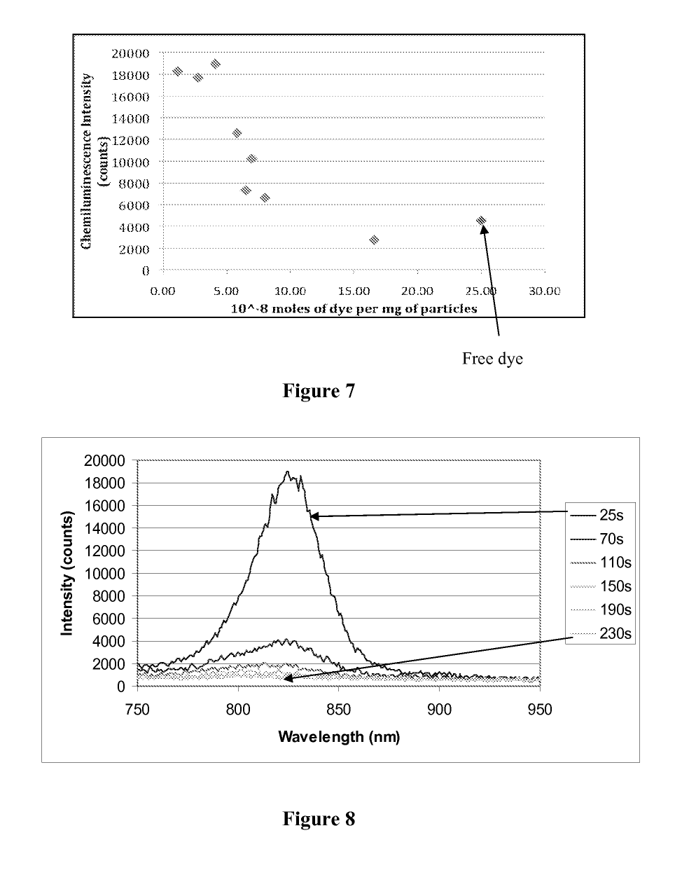

For a more detailed view of the differences between the particles and the dye, the maximum intensity peak (25 s) of the chemiluminescence for all particles is shown in FIG. 7. The intensity peak for the free dye is shown in at 25×10̂−8 moles per mg of particles. Please note that this concentration value is just a placeholder.

In general, the graph shows that the chemiluminescence of the particles decreases with the higher the amount of incorporated dye. The first three particle types show about the same chemiluminescence intensity whereas the rest of the particle types drop in intensity. To explain this observation, several interpretations are possible.
a) One problem might be quenching because the dye molecules are in closer proximity to one-another in particles with a higher amount of dye.
b) The porosity is not as good for particles with more incorporated dye. In particles with a lower amount of dye, the pore structure is better retained and the dye molecules are more easily accessible.
c) The base that was used, potassium hydroxide, might be reacting with the dye. This would explain why the chemiluminescence intensity for the free dye is very low.
   A plot of chemiluminescence decay is shown for 0.10 mol % particles as an example in FIG. 8.

Chemiluminescence Activation with Hydrogen Peroxide

Similar experiments were made without base activation. 1 mL of each prepared particle type and dye solution was activated with 12 μL hydrogen peroxide (30%). The solvent for particles and dye was n-hexanol and ethyl acetate with the content of phenyloxalate as described earlier.

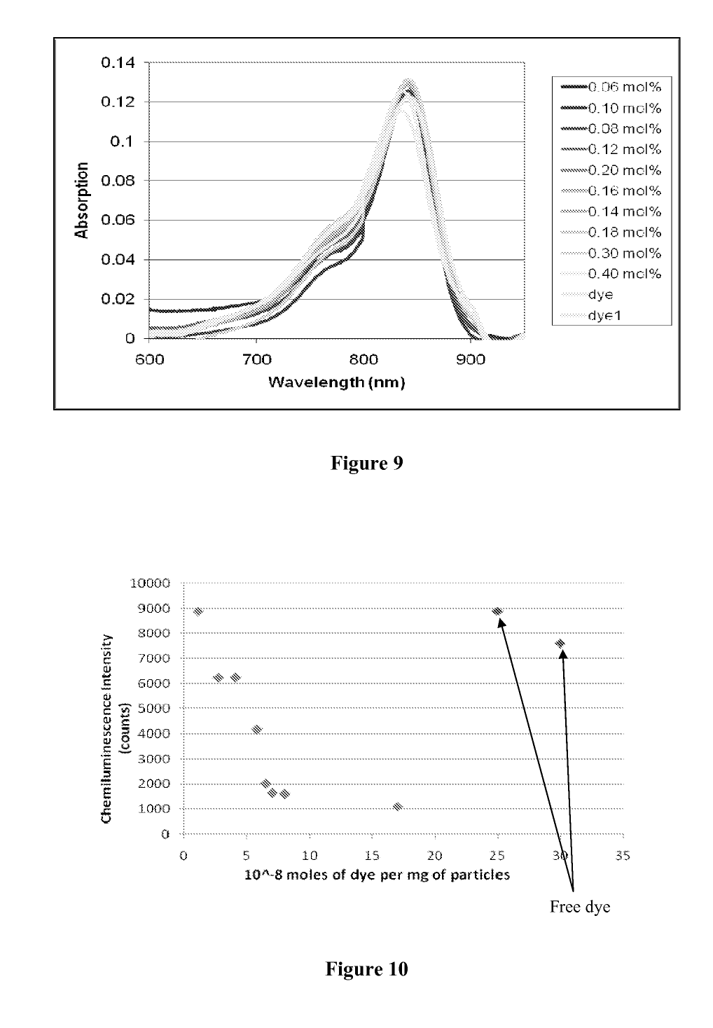

The different particles were absorption matched, as shown in FIG. 9, to allow comparison of the results. To match the absorption, the prepared nanoparticle and dye solutions were each diluted with a mixture of n-hexanol, ethyl acetate and phenyloxalate (same composition as described above).

FIG. 10, the maximum intensity peak (25 s) of the chemiluminescence is shown for all absorption matched particle types. The intensity peaks for the free dye are shown at 25×10̂−8 moles and 30×10̂−8 moles per mg of particles. Please note that these dye concentration values are just placeholders.

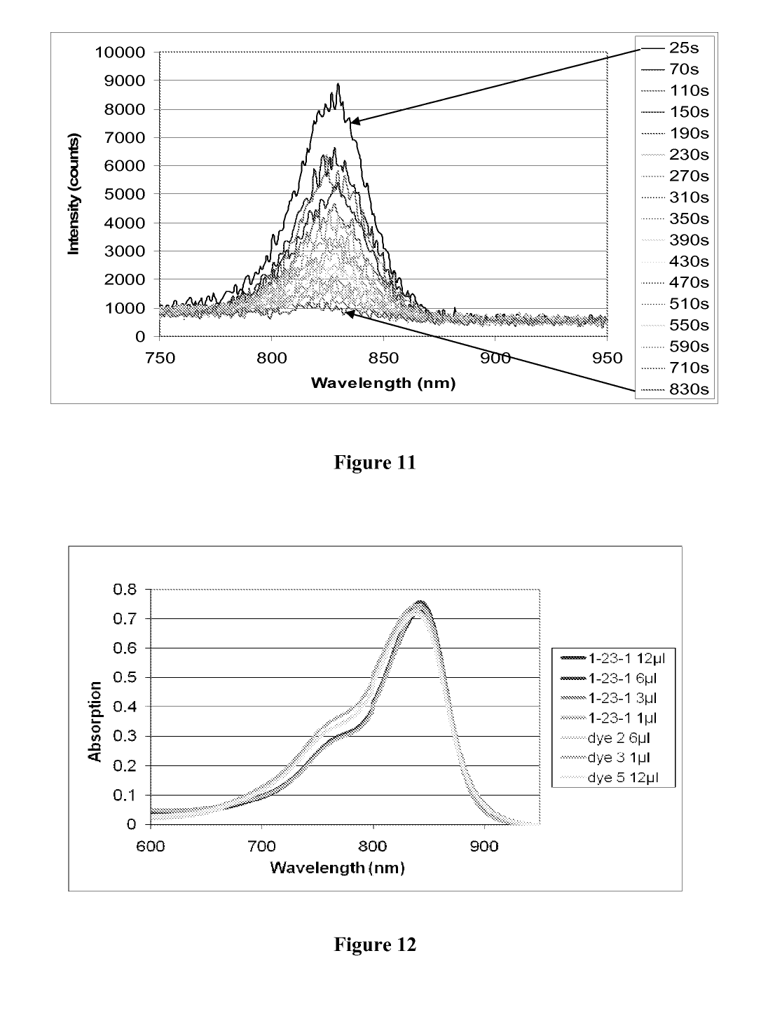

Again, the intensity increases with a lower amount of incorporated dye (similar to chemiluminescence tests with base activation). However, the highest intensity achieved by any particle type was approximately half as much as with KOH activation. This seems to indicate that the presence of KOH is important to increase the brightness seen from the particles. But at the same time as the intensity decreases, an increase in the chemiluminescence duration was observed. This indicates that the reaction was slowed down in absence of the base catalyst. In FIG. 11 the chemiluminescence decay for 0.06 mol % particles is shown as an example. The chemiluminescence lasts approximately 14 minutes and is three times as long as with H₂O₂/KOH activation.

Besides the different particle behaviour, the absorption matched free dye solution shows a chemiluminescence intensity that is as high as for the 0.06 mol % particles. Since the experiments with free dye solution and base have shown a very low intensity, this new result reinforces the assumption that the potassium hydroxide interacts with the dye molecules.

### Hydrogen Peroxide Sensitivity of the System

Since the system that has been developed is a good indicator for hydrogen peroxide and silica nanoparticles are promising candidates for biocompatibility, it is worth considering applying the particles to living organisms like cells. Certainly, for a biological application of the particles it is important to optimize any sensing system. For instance it is essential to increase the sensitivity of the system.

To investigate hydrogen peroxide concentrations in human tumor cells, sensitivity of the particles is of utmost importance. It is known that these cells produce up to 0.5 nmol/10⁴ cells/h of hydrogen peroxide. This is a very low concentration of hydrogen peroxide per single tumor cell. Right now, the particles reach a sensitivity of 0.33 μmol hydrogen peroxide per millilitre of particle solution. This indicates that an optimization of the system is unavoidable. Besides chemical optimizations, instruments with a higher sensitivity are recommended for a biological application of the system.

Furthermore it is necessary to integrate the oxalate into the nanoparticles, because molecules, other than hydrogen peroxide, that are located in cells could react with free oxalate. If the oxalate is incorporated into the nanoparticle, false positives for hydrogen peroxide would be decreased.

Since molecules in the cell do not show absorption in the near infrared region, the application of a near infrared dye could be advantageous. Nevertheless, it is known that near infrared dyes show a lower chemiluminescence compared to other dyes. Usage of a visible dye could increase the sensitivity of the system and the brightness of the chemiluminescence.

A good starting point for an optimization of the system was to test the hydrogen peroxide sensitivity of the system by decreasing the amount of added hydrogen peroxide. For initial experiments and to compare the results with free dye, all solutions were absorption matched again, as shown in FIG. 12. Representative nanoparticles for the measurements were those with 0.08 mol % of incorporated dye.

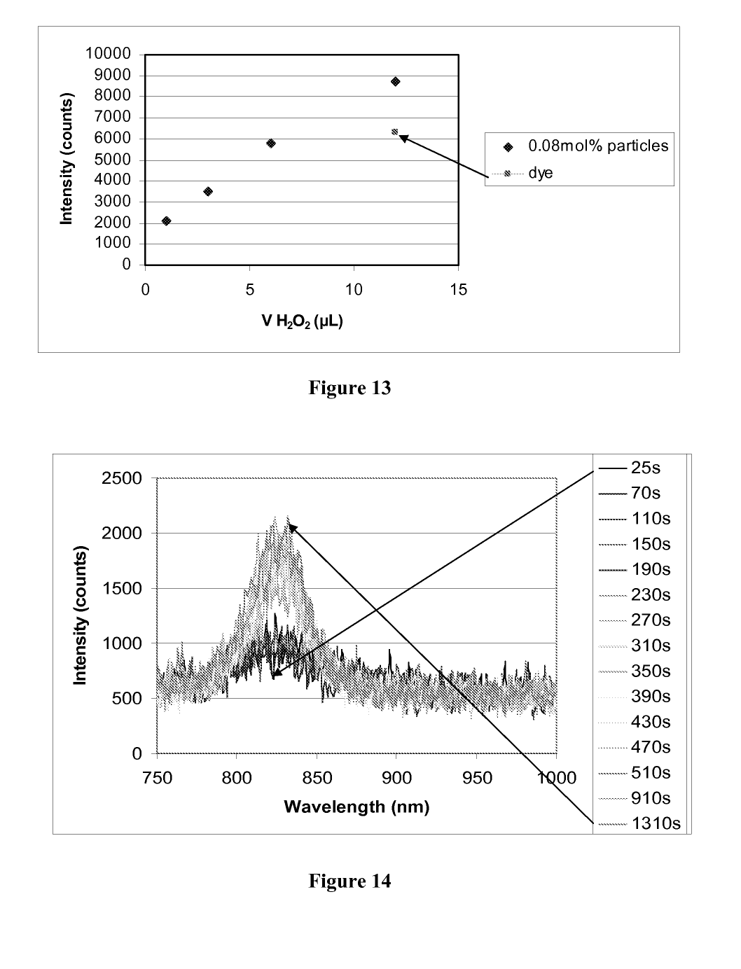

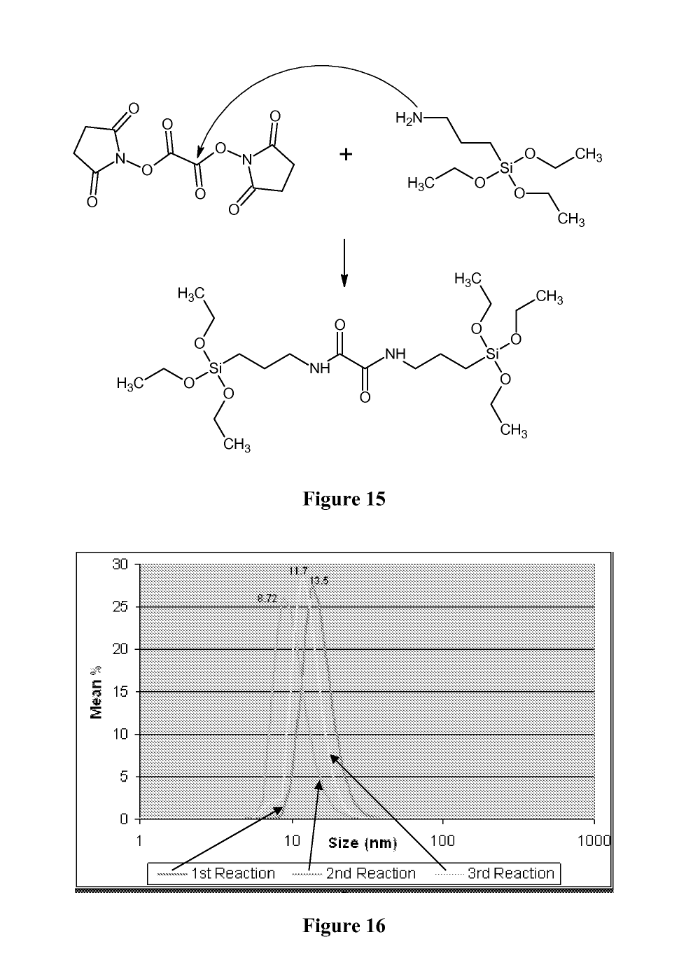

Hydrogen peroxide (30%) volumes of 12 μL, 6 μL, 3 μL and 1 μL were added to 1 mL of the absorption matched nanoparticle solutions. As shown in FIG. 13, the chemiluminescence intensity decreases with lower amounts of hydrogen peroxide added. These results were expected, because less of the activating molecules are available for the reaction.

Another observation is that at the same time that the volume of hydrogen peroxide added was decreased, the duration of the chemiluminescence increased.

The behavior of free dye solution is not clear yet. It seems that the chemiluminescence increases with time when lower amounts of hydrogen peroxide were added, as shown in FIG. 14, whereas the chemiluminescence intensity drops constantly when more hydrogen peroxide is added, as shown by the arrow in FIG. 13.

### EXAMPLE 2

### Preparation and Characterization of Core-Shell Nanoparticles Containing Absorber Dye Experimental Methods

Dye Selection. The absorption dyes were selected based on their characteristic reactive groups and absorption peak wavelength. The dyes used in the experiments were 6-(2,4-dinitrophenyl)aminohexanoic acid, succinimidyl ester (DNP-X) with an absorption peak at approximately 350 nm and QXL490 C2 amine with an absorption peak at 485 nm. These two dyes allow research of core-shell nanoparticles with absorbing dyes to delve into both the ultraviolet (DNP-X) and visible (QXL490) regions of the absorption spectrum.

Particle Formation. To produce core-shell nanoparticles with the DNP-X and the QXL490 dyes three 25 mL, 20 nm particle reactions based on the Stober method for silica nanoparticle synthesis were sequentially run for each dye. One 25 mL, 100 nm particle reaction was also run for each dye.

The dyes, as purchased were packaged as a powder. For ease of handling and precision of measurement each powdered dye was dissolved in dimethyl sulfoxide (DMSO) to obtain a desired concentration. The dyes were then conjugated with a silica precursor. This was done using isocyanatopropyltriethoxysilane (ICPTS) and aminopropyl triethoxysilane (APTS) for the DNP-X SE and the QXL490 amine, respectively. This conjugation reaction was placed on a stir plate and allowed up to 24 hours to react.

To form the dye-rich cores of the core-shell nanoparticles, a mixture of ethanol, water, and ammonia were left to stir for 24 hours with the conjugated dye and tetraethylorthosilicate (TEOS). Once the core reaction was completed, the silica shell was created by the addition of more TEOS and an additional 24 hours of reaction time. This created the core-shell structure of core-shell nanoparticles, a dye-rich core and silica shell.

Particle Cleaning and Measurements. The final solution containing the core-shell nanoparticles was a mixture of ethanol, water, and ammonia as well as any unreacted dye, or TEOS that had not been consumed in the formation of the particles. A clean solution of only particles and ethanol is desirable to obtain exact measurements of absorption and analysis of particle size. Therefore, a sample of the native solution was dialyzed using 3500MWCO dialysis tubing in stirring ethanol for at least 8 hours. After sufficient time had passed, the clean solution of particles within the bag was removed and stored in a sealed vial. The remaining native solution of particles was also stored in a separate sealed vial.

To verify that the core-shell nanoparticles had properly formed and the dye had been successfully incorporated into the particles, two measurements were necessary. To determine the size of the particles, samples were placed into quartz cuvettes and a Brookhaven dynamic light scattering (DLS) device was utilized. This machine determines particle size from the pattern resulting from the light scattering off of the particles when a laser beam is passed through a dilute solution of particles. For verification that the absorbing dye was properly incorporated in the particles, a spectrophotometer was utilized to measure absorption. A sample of each free dye was diluted by a factor of 100 and used for comparison with the newly made core-shell nanoparticles. The spectrophotometer was set to a spectral range of 300 nm to 450 nm with 2 nm step intervals for DNP-X and 390 nm to 590 nm, again at 2 nm step intervals, for QXL490. The solvent used to dilute the dye and particle samples was ethanol. This solution was chosen based on its refractive index, which matches that of the silica shell of the particles. Therefore this solvent reduces the effect of light scattering, at the solvent to particle shell interface, which can mask the absorptive properties being measured. SEM (scattering electron microscope) images were taken of each reaction of particles for further verification of size distribution. For the larger particles, these SEM images also provide information on the porosity of the particle surface.

### RESULTS

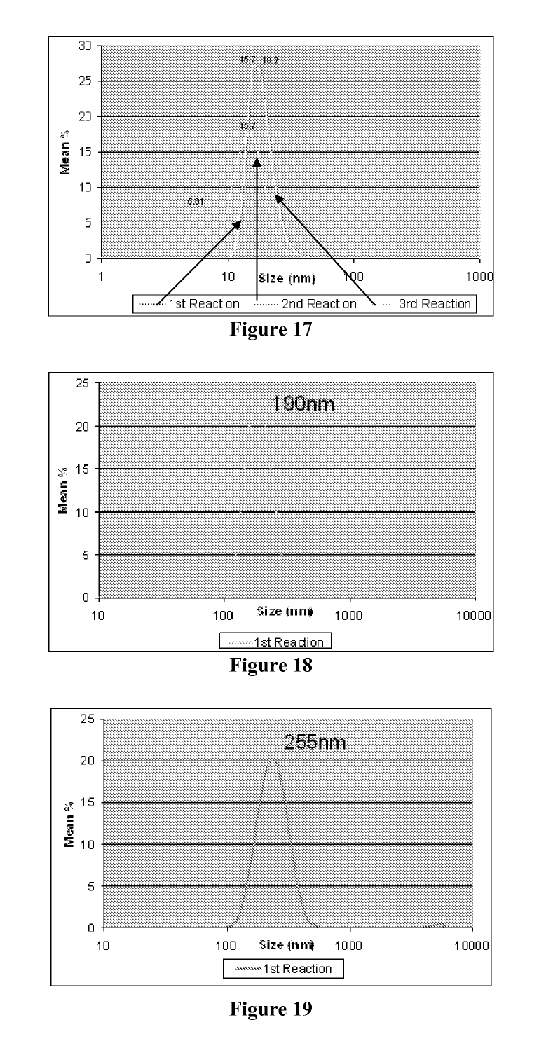

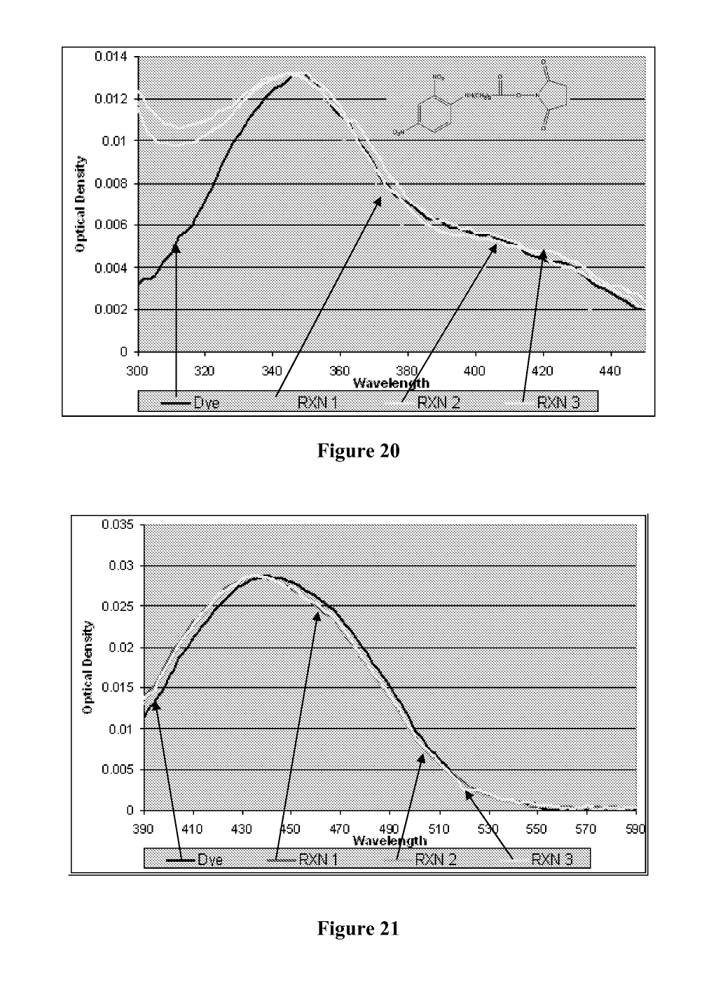

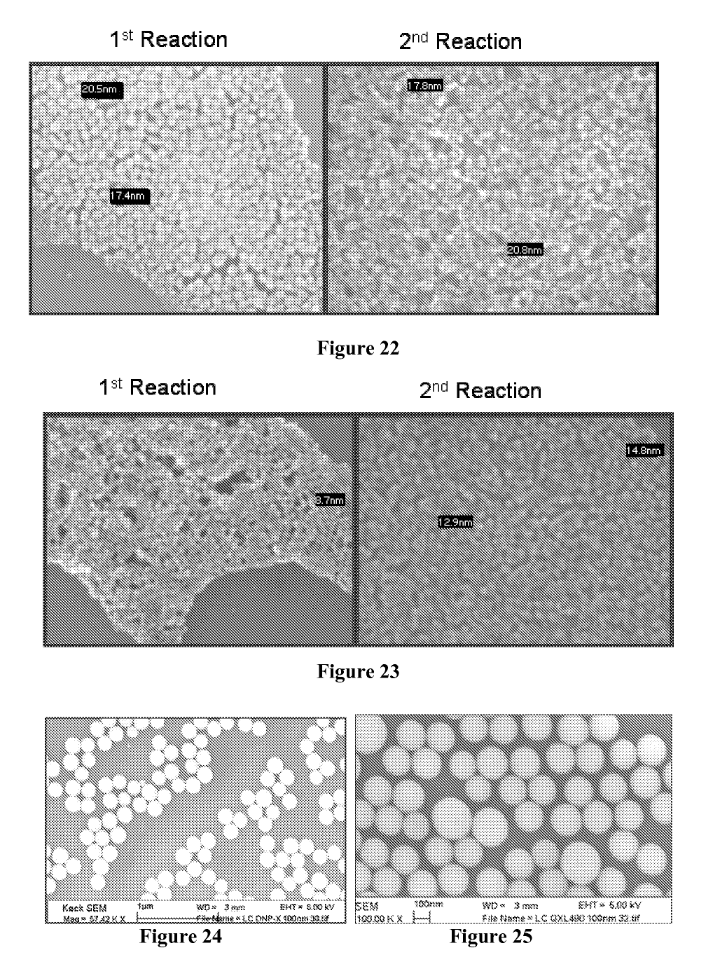

Once dissolved in ethanol, DNP-X produced a bright yellow solution and QXL490 produced a bright orange solution. During conjugation of the dyes both solutions became a slightly lighter version of the pure dye solution due to dilution. The formation of cores lightened the conjugated dye by dilution such that DNP-X became a translucent yellow and the QXL490 became a bright yellow. Sediment at the bottom of the flasks was not found after the formation of cores or after the shell addition. The existence of sediment at either of these steps would have been an indication that particles were not properly created. The data obtained from both the DLS and the spectrophotometer for all three runs of the 20 nm particles and the DLS data for the first run of 100 nm particles were plotted in graphs. The 20 nm size data from the DLS is displayed in FIG. 16 and FIG. 17. The three sets of QXL490 particles have similar majority sizes ranging from 8.72 nm to 13.5 nm and the three sets of DNP-X particles have majority diameters ranging from 15.7 nm to 18.2 nm. The DLS size data for the 100 nm reactions are shown in FIG. 18 and FIG. 19. The majority size of the DNP-X 100 nm reaction is 190 nm and the majority size of the QXL490 100 nm reaction is 255 nm. The spectrophotometry data was corrected for the cuvettes and solvent (ethanol) by subtracting measured reference data. This was done for both the dye and particle samples. The particle samples were then normalized to the dye data. FIG. 20 and FIG. 21 show the absorption data for DNP-X dye and particles and QXL490 dye and particles, respectively. The peak absorption for the QXL490 dye is 440 nm and approximately 2 nm greater for the QXL490 particles. The peak absorption for the DNP-X dye occurs at 348 nm and approximately 2 nm less for the DNP-X particles. SEM pictures for the two 20 nm reactions and the 100 nm reaction are shown in FIGS. 22-25.

### DISCUSSION

The particle sizes obtained from the DLS data for DNP-X and QXL490 are on the same order of magnitude as the approximated value of 20 nm, verifying that particles had been formed. The secondary nucleation observed in the second reaction of 20 nm DNP-X particles is assumed to be due to slight variations in the reaction parameters of timing or concentration. Since the majority peak is sill in line with the first and third reaction and the secondary peak is not of a different order of magnitude, its existence can be ignored. The SEM images for the first two reactions coincide in terms of size of the particles providing validity for the DLS data. The size data from the exploratory 100 nm reactions are both larger than 100 nm, however, because the 100 nm is only a name for the reaction parameters based on reactions with fluorescent TRITC dye, the larger sizes provide a starting point for these new dyes and do not indicate any problems. Again the particle size observed in the SEM coincides with the DLS data, proving the DLS size data actually results from the particles size and not aggregation. Also, the surface of both sets of 100 nm reactions show uniform smooth spherical particles in SEM, which indicates that the reaction was successful in forming a non-porous protective shell.

The absorption data for the 20 nm reactions verify that the dye was successfully incorporated into the silica core-shell architecture, was not quenched in the process, and did not leach out during dialysis. There was no shift in the peak absorption intensity for the DNP-X dye and particles from the literature value. The dye and particles in ethanol have the same absorption peak, indicating that the incorporation of the DNP-X dye into the particles did not disturb the peak absorptive property. The QXL490 dye and particles have a slight blue shift of approximately 60 nm from the literature value of 490 nm. However, this is expected due to a difference in measurement solvent; the literature value is reported for measurements made in methanol as opposed to the ethanol which was used in this measurement. Importantly, both the dye and the particles have the same peak indicating the incorporation of the dye into the particles was once again successful.

The objective, to produce approximately 20 nm core-shell nanoparticles using the absorptive dyes DNP-X and QXL490, was successful. Both size analysis and absorption measurements showed that the particles incorporated dye without disturbing the absorptive properties or quenching the dye. After three runs using the same 20 nm particle reactions repeatable results were observed. The absorption peaks of the particles, colors of the solution during each step of the process, particle size distribution, and shape uniformity from the SEM images were consistent for multiple reactions. Color comparisons at each step in the three reactions indicated procedural consistency.

The 100nm particle reactions were successful in making larger core-shell nanoparticles. Absorption measurements were taken to verify that the dye was in fact incorporated. Similar reactions were run to produce 60 nm, 250 nm particles, and particles up to 700 nm in diameter. Additionally, other dyes in the NIR were successfully incorporated into core-shell nanoparticles.

While the invention has been particularly shown and described with reference to specific embodiments (some of which are preferred embodiments), it should be understood by those having skill in the art that various changes in form and detail may be made therein without departing from the spirit and scope of the present invention as disclosed herein.

What is claimed is:

1) A silica nanoparticle having a mesoporous structure comprising absorbing material,
wherein the absorbing material is covalently linked to the silica network,
wherein the absorbing material absorbs electromagnetic energy of from 300 nm to 1200 nm, and wherein on exposure to an appropriate chemical species the absorbing material exhibits chemiluminescent emission,
wherein the longest dimension of the nanoparticle is 1 to 500 nm.

2) The silica nanoparticle of claim 1, wherein the nanoparticle further comprises a chemical species which can react to form a high-energy chemical species which on exposure to the absorbing material results in chemiluminescent emission.

3) The silica nanoparticle of claim 2, wherein the chemical species which can react to form a high-energy chemical species which on exposure to the absorbing material results in chemiluminescent emission comprises an oxalate moiety.

4) The silica nanoparticle of claim 1, where in the silica nanoparticle has a pores of from 1 to 20 nm.

5) The silica nanoparticle of claim 1, wherein the longest dimension of the nanoparticles is from 1 to 100 nm.

6) The silica nanoparticle of claim 1, wherein the absorbing material is an organic dye.

7) The silica nanoparticle of claim 1, wherein absorbing material is ADS832WS, succinimidyl ester (DNP-X SE) or QXL-490.

8) A silica nanoparticle, wherein the nanoparticle comprises a core comprising an absorbing material, wherein the absorbing material is covalently linked to the silica network of the core, wherein the absorbing material absorbs electromagnetic energy of from 300 nm to 1200 nm, and wherein on exposure to an appropriate chemical species the absorbing material exhibits chemiluminescent emission,
wherein the shell comprises silica, and
wherein the longest dimension of the nanoparticle is 1 to 500 nm.

9) The silica nanoparticle of claim 8, wherein the nanoparticle further comprises a chemical species which can react to form a high-energy chemical species which on exposure to the absorbing material results in chemiluminescent emission.

10) The silica nanopartice of claim 8, wherein the chemical species which can react to form a high-energy chemical species which on exposure to the absorbing material results in chemiluminescent emission comprises an oxalate moiety.

11) The silica nanoparticle of claim 8, wherein the longest dimension of the nanoparticles is from 1 to 100 nm.

12) The silica nanoparticle of claim 8, wherein the absorbing material is an organic dye.

13) The silica nanoparticle of claim 8, wherein absorbing material is ADS832WS, succinimidyl ester (DNP-X SE) or QXL-490.

14) A method for detecting a chemical species comprising the steps of:
a) providing a mesoporous nanoparticle of claim 1;
b) exposing the mesoporous nanoparticle to an environment comprising an analyte chemical species under conditions resulting in chemiluminescent emission from the mesoporous nanoparticle; and
c) detecting the chemiluminescent emission which demonstrates the presence of the analyte chemical species.

15) The method of claim 14, wherein the mesoporous nanoparticle further comprises pores which are functionalized with a surfactant, such that the diffusion of a chemical species is altered relative to mesoporous nanoparticles which are not functionalized.

16) The method of claim 14, wherein the providing in step a) includes providing a plurality of mesoporous nanoparticles of claim 1, wherein the plurality includes at least two different mesoporous nanoparticles.

17) The method of claim 16, wherein the at least two different mesoporous nanoparticles have different absorber material and/or size and/or pore size and/or pore functionalization.

18) The method of claim 14, wherein the analyte is hydrogen peroxide.

19) The method of claim 14, wherein the environment further comprises a chemical species which can react with the analyte to form a high-energy chemical species.

20) The method of claim 19, wherein the chemical species which can react with the analyte is oxalate.
